(19) United States
(12) Patent Application Publication
(10) Pub. No.: US 2022/0185019 A1
(43) Pub. Date: Jun. 16, 2022

(54) TIRE WITH PROTECTIVE BELT STRUCTURE

(71) Applicant: The Goodyear Tire & Rubber Company, Akron, OH (US)

(72) Inventors: Frank Anthony Kmiecik, Akron, OH (US); Leonard James Reiter, Ravenna, OH (US); Philip Carl Van Riper, Cuyahoga Falls, OH (US); Pablo Rafael Morales, Brimfield, OH (US)

(21) Appl. No.: 17/452,269

(22) Filed: Oct. 26, 2021

Related U.S. Application Data
(60) Provisional application No. 63/126,049, filed on Dec. 16, 2020.

(51) Int. Cl. B60C 9/20; B60C 9/00

(52) U.S. Cl. CPC B60C 9/20; B60C 9/0042; B60C 2009/2096; B60C 2009/2077; B60C 2009/2012; B60C 9/2003

(57) ABSTRACT

A tire having a jointless cut protector belt, wherein the jointless cut protector belt is continuously wound using a strip of one or more reinforcement cords, wherein the strip of one or more reinforcement cords is wavy, extending primarily in the circumferential direction, and preferably wound in a sine wave pattern.

### FIELD OF THE INVENTION

The invention relates generally to tires and more particularly to heavy duty tires, such as truck, bus or aircraft tires.

### BACKGROUND OF THE INVENTION

Aircraft, truck or bus tires are typically retreaded in order to reuse the large and complex tire carcass multiple times. However, the treads of truck, bus or aircraft tires may be subject to frequent punctures from stones or other sharp objects in the road or runway surface. The frequency and severity of punctures may cause the tire carcass to be scrapped. Cut protector belts are typically used to try and prevent the carcass from being damaged. However, cut protector belts are often not stiff enough to prevent the damage to the carcass. The sharp object tends to move the belt out of the way in order to pierce the carcass.

FIG. 1 illustrates a load vs. deformation curve representative for a cut protector belt with reinforcements. Area 10 represents the reinforcement cord preload due to the tire pressure when inflated, and the design goal is to minimize this area 10. Area 20 represents the cut energy absorption capacity, with the design goal to increase the area 20. While controlling the modulus of the primary belt material, using a higher modulus reinforcement for the cut protector layer increases the total area (Sum of 10 and 20) while increasing the ratio of 10/20. Using a lower modulus reinforcement decreases the total area, while also decreasing the ratio of 10/20. Thus, the goal of increasing area 20 while decreasing area 10 are in opposition.

Thus, a cut protector belt that has improved cut resistance to foreign object damage, is desired. The improved cut protector belt can be used on new or retreaded tires to improve the service life of the tire carcass.

### SUMMARY OF THE INVENTION

The invention provides in a first aspect a tire having a cut protector belt located radially outward of a main belt structure, wherein the cut protector belt is a structure that has 1 or multiple layers of cord formed below the tread and above the primary belt reinforcing structure. This structure is formed a ribbon of parallel cords having 1 to 20 cords in each ribbon and laid up in repeating wave pattern, with an average angle of approximately 0 degrees.

The invention provides in a second aspect a tire having a jointless cut protector belt, wherein the jointless cut protector belt is continuously wound using a strip of one or more reinforcement cords, wherein the strip of one or more reinforcement cords is wound in a sine wave pattern.

The invention provides in a third aspect a tire having a jointless cut protector belt, wherein the jointless cut protector belt is continuously wound using a strip of one or more reinforcement cords, in a wavy pattern that extends in the circumferential direction.

The invention provides in a fourth aspect a tire having a jointless cut protector belt that is continuously wound using a strip of one or more reinforcement cords, wherein the one or more reinforcement cords are formed of aramid, nylon or a blend thereof.

### Definitions

“Aspect ratio” of the cord means the ratio of its height (H) to its width (W) multiplied by 100 percent for expression as a percentage.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tire dimensioned and configured in segment for receipt of an air tube therein.

“Lateral” means an axial direction.

“Lateral edges” means a line tangent to the axially outermost tread contact patch or footprint as measured under normal load and tire inflation, the lines being parallel to the equatorial centerplane.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tread element” or “traction element” means a rib or a block element defined by a shape with adjacent grooves.

“Tread Arc Width” means the arc length of the tread as measured between the lateral edges of the tread.

“Zigzag belt reinforcing structure” means a belt structure formed of at least two layers of cords interwoven together wherein a ribbon of parallel cords having 1 to 20 cords in each ribbon are laid up in an alternating pattern extending at an angle typically between 5° and 45° between lateral edges of the belt, and more preferably between 3 and 11 degrees, and most preferably between 5 and 11 degrees.

### BRIEF DESCRIPTION OF THE DRAWINGS

The invention will be described by way of example and with reference to the accompanying drawings in which:

FIG. 1 illustrates a load vs. deformation curve for a cut protector reinforcement to break, wherein the portion 10 represents cord preload due to inflation, and area 20 represents cut energy ab sorption capacity;

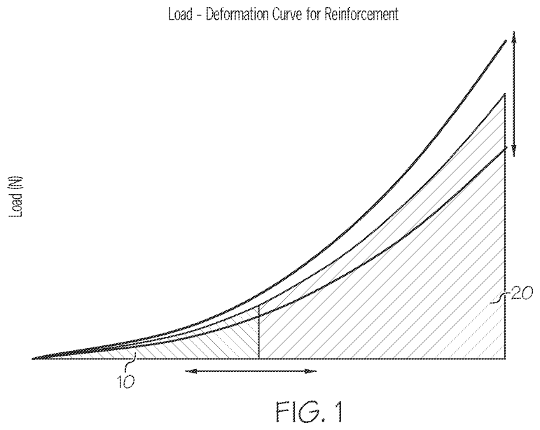

FIG. 2 illustrates a cross-sectional view of one half of a tire of the present invention;

FIG. 3 is a close-up perspective view of the upper portion of FIG. 2 showing the cut protector belt and belt package of the present invention;

FIG. 4 illustrates the cut protector belt, as if laid out into a flat position, from zero to 360 degrees;

FIG. 5 illustrates a front view of a tire carcass with the application of a continuously wound ribbon of cords forming a jointless cut protector belt having a wavy pattern;

FIG. 6 is a three dimensional scatter plot of turn radius, sin per revolution, and % extra cord;

FIG. 7 is a three dimensional scatter plot of turn radius, amplitude and % extra cord;

FIG. 8 illustrates the strip of cord being applied by an applier to the carcass; and

FIG. 9 illustrates the turn radius.

### DETAILED DESCRIPTION OF THE PRESENT INVENTION

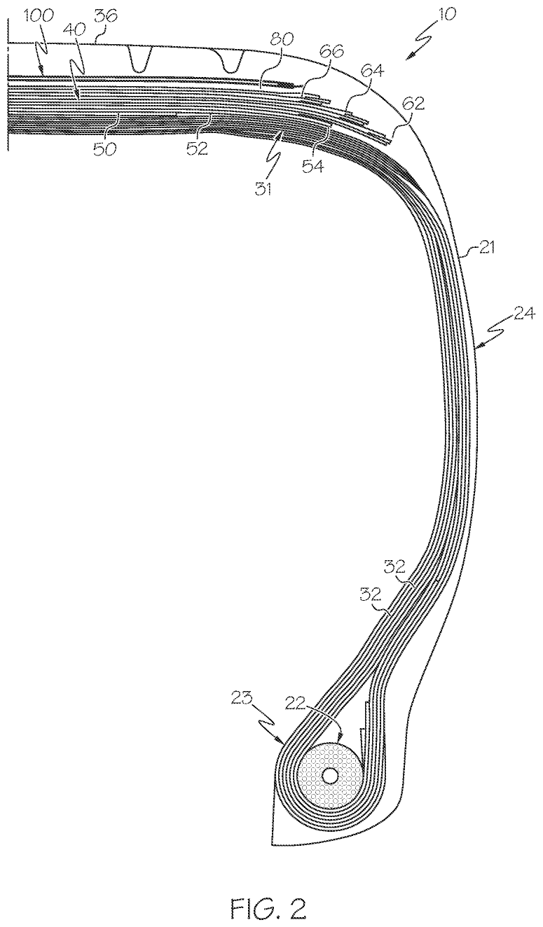

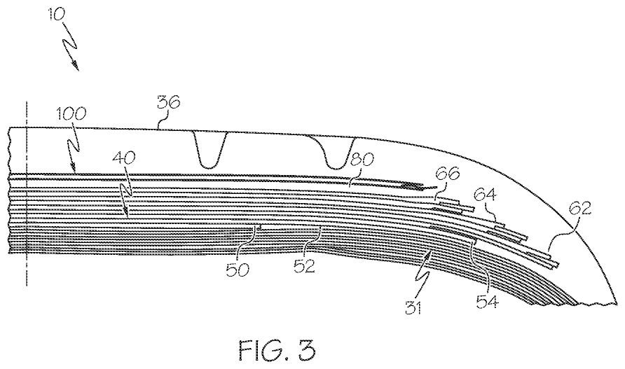

FIGS. 2-3 illustrates a cross-sectional view of a first embodiment of a tire 10 of the present invention. The radial tire in this example is an aircraft tire, which includes a pair of bead portions 23 each containing a bead core 22 embedded therein, a sidewall portion 24 extending substantially outward from each of the bead portions 23 in the radial direction of the tire, and a tread portion 36 of substantially cylindrical shape extending between radially outer ends of these sidewall portions 24. Furthermore, the tire 10 is reinforced with a carcass 31 toroidally extending from one of the bead portions 23 to the other bead portion 23. The carcass 31 is comprised of at least two carcass plies 32, e.g., six carcass plies 32 in the illustrated embodiment. Among these carcass plies 32, four inner plies are wound around the bead core 22 from inside of the tire toward outside thereof to form turnup portions, while two outer plies are extended downward to the bead core 22 along the outside of the turnup portion of the inner carcass ply 32. Each of these carcass plies 32 contains many nylon cords such as nylon-6,6 cords extending substantially perpendicular to an equatorial plane E of the tire (i.e. extending in the radial direction of the tire).

A belt package 40 is arranged between the carcass 31 and the tread rubber 36 and is comprised of one or more belt plies 50,52, 54 preferably the radially innermost belts which are located near the carcass 31. Preferably, the one or more belt plies 50,52,54 are low angle belts, with a belt angle of 10 degrees or less, more preferably with a belt angle of 5 degrees or less. Preferably, the one or more low angle belts 50,52,54 increase in width from the radially innermost belt 50 to the radially outermost belt 54.

The belt package preferably includes one or more zigzag belt structures 62,64,66 located radially outward of the low angle belts 50,52,54. Each of the radially outer zigzag belt structures is formed by winding a rubberized strip 43 of one or more parallel reinforcement cords 46 generally in the circumferential direction while being inclined to extend between side ends or lateral edges 44 and 45 of the layer forming a zigzag path and conducting such a winding many times while the strip 43 is shifted at approximately a width of the strip in the circumferential direction so as not to form a gap between the adjoining strips 43. The strip of reinforcement cords preferably has a width W, W being in the range of 0.2 to 1.5 inches. It is preferable that the strip width W should be 1.0 inch or less to facilitate bending to form the zigzag paths of the inner and outer layers 41, 42.

The belt package may further include a top belt or cut protector belt 100 that is the radially outermost belt. The cut protector belt 100 is shown in FIGS. 3-5, and is formed of a continuously wound strip of reinforcement cords to form a jointless belt. The cut protector belt may be a single belt layer or multiple belt layers. The continuously wound strip is formed in a wave configuration. The wave configuration is preferably a sine wave and extends primarily in the circumferential direction. The jointless cut protector belt is formed by continuously winding strip. The strip is formed of one or more parallel reinforcements encased in rubber.

The reinforcement cords of the strip may comprise one or more parallel reinforcement cords made of nylon, nylon 6,6 or aramid reinforcement cords. Preferably, the reinforcement cord is aramid having a high twist construction. Preferably, the aramid cord construction is 3000/1/3 dtex with 6 twists per inch. Preferably, the reinforcement cords of the strip are high modulus cord reinforcements, such as hybrid or merged cords of nylon and aramid. More preferably, the cord construction is 3000 d/2 aramid and 1680 d/1 nylon. Preferably, the strip of reinforcement cords used to form the cut protector belt ranges in width from about 0.25 to about 0.5 inches, and has 4-10 number of reinforcement cords.

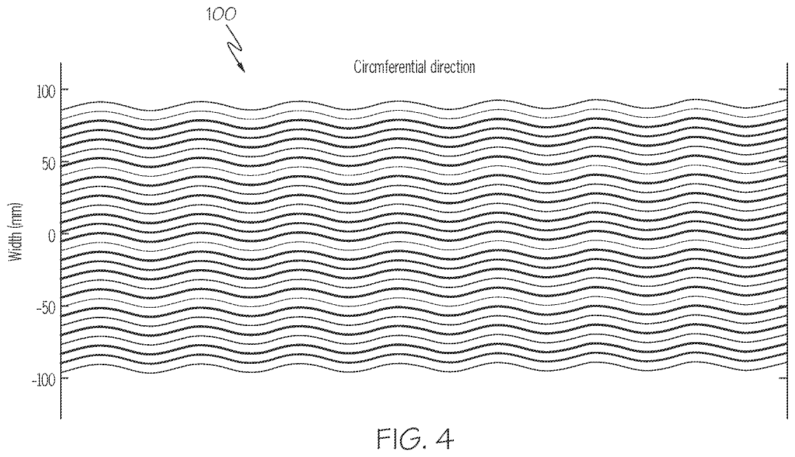

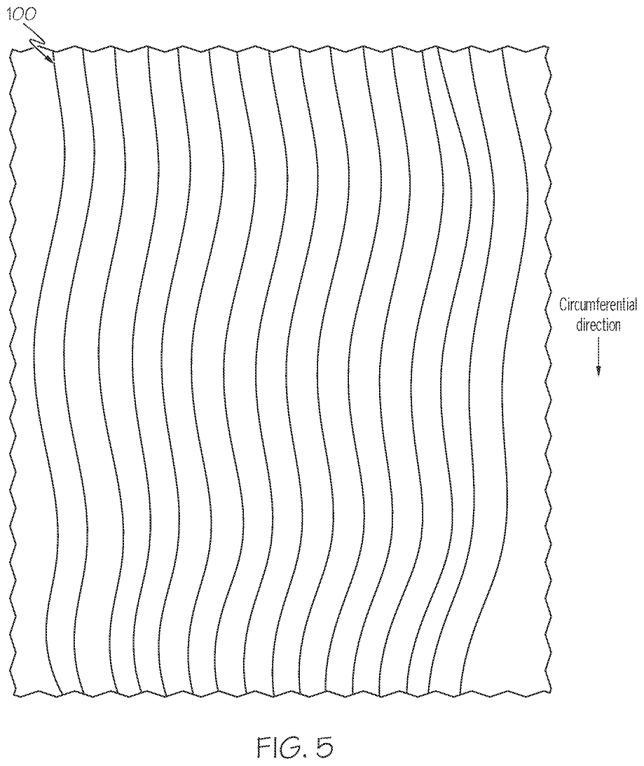

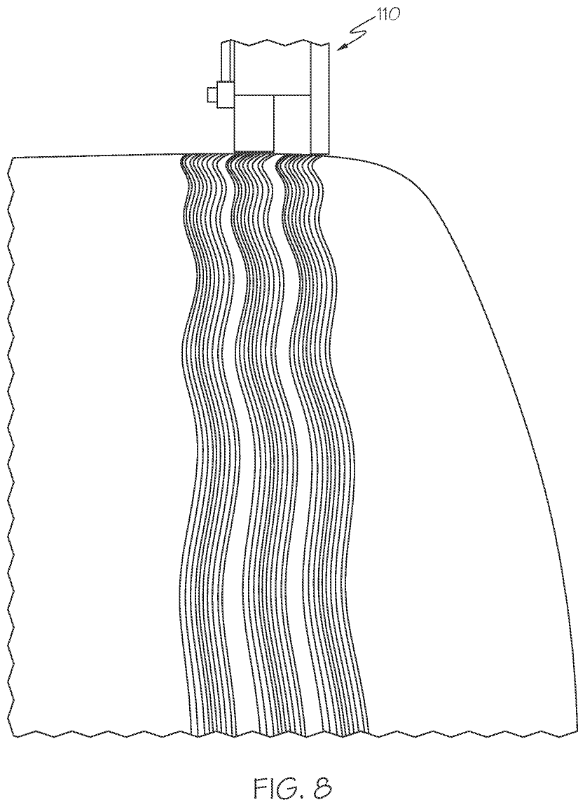

The cut protector belt 100 preferably has a width which extends from a first shoulder to a second shoulder, i.e., full belt width. Preferably, the cut protector belt width is 1.5-2 inches inboard from the widest belt width to minimize durability risk. FIG. 4 illustrates the cut protector belt from 0 to 360 degrees. As shown in FIG. 8, the cut protector belt 100 is formed by an applier head 110 that lays the continuous strip of reinforcement cords directly onto the carcass (of either a new tire or a retread) using a sine wave curve. FIG. 5 illustrates the formed cut protector belt 100 onto the tire carcass, with no gaps in between the belt windings. Advantageously, the jointless cut protector belt eliminates cut belt ends of conventional wavy belt layers. Prior art wavy belt layers are typically formed in a calendered sheet, which is then applied to the carcass by splicing the outer lateral ends of the sheet together. The disadvantage to the splice is that it is a huge nonuniformity that can contribute to tread loss, as well as requiring additional manufacturing complexity.

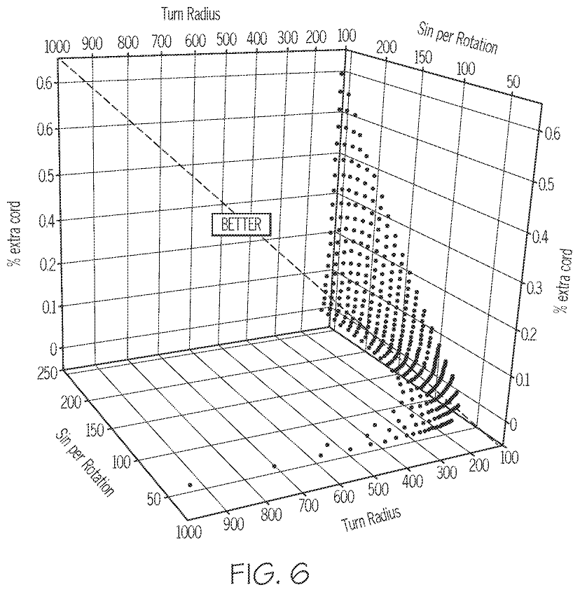

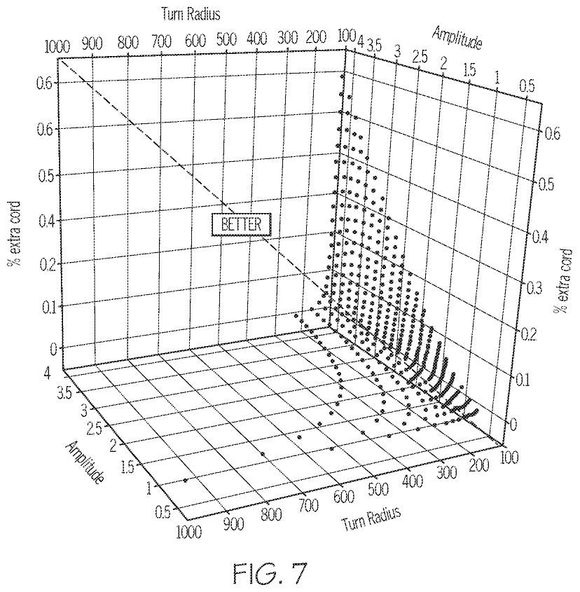

The period ranges from 50 mm to 100 mm and more preferably from 75 mm to 100 mm. While it is desired to minimize the period, it is constrained due to the application method. The % extra cord ratio referred to herein, and shown in FIGS. 6-7, means the actual length of the cord used to form the sine wave in one revolution divided by the circumferential length of the application surface. The % extra cord ratio ranges from 101% to 115% and more preferably from 101% to 105%. The higher the ratio, the more the cord is unloaded or “loose.” Looser or unloaded cords maximize the cut resistance for a given material modulus.

The amplitude of the sine wave affects the extra cord %. As the amplitude increases, so does the extra cord %. Preferably, the sine wave amplitude ranges from 1-5 mm, and more preferably, from 2. mm to 3.5 mm, and more preferably from 2.5 mm to 3 mm. Amplitudes exceeding 5 mm can lead to unfavorable tire appearance.

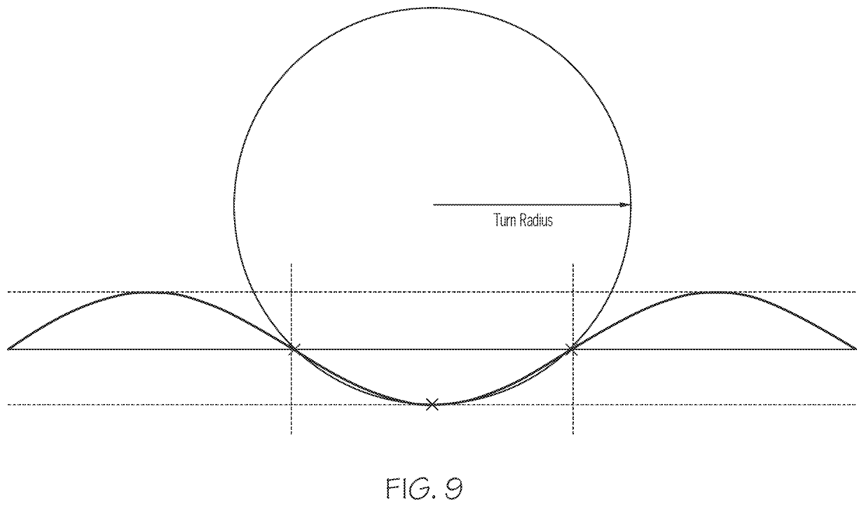

The turn radius is minimized up to the limit of strip buckling. The turn radius is defined as the radius of the circle traversing between three points on the sine wave as shown in FIG. 9. Preferably, the two outer points are where the sine wave intersects the neutral axis of the wave, and the third point is at the peak amplitude located between the two outer points. As the turn radius decreases, the % extra cord increases, resulting in more loose cord per area, which is desired for FOD protection. The turn radius is preferably minimized, more preferably in the range of 50 to 100 mm. Using the 0.5″ strip a turn radius of 75 mm is preferred as it can be consistently maintained from a quality perspective.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A tire having a jointless cut protector belt, wherein the jointless cut protector belt is continuously wound using a strip of one or more reinforcement cords, wherein the strip of one or more reinforcement cords is wound in a sine wave pattern.

2. The tire of claim 1 wherein the sine wave pattern extends in the circumferential direction.

3. The tire of claim 1 wherein the one or more reinforcement cords are 3000/1/3 dtex with 6 twists per inch.

4. The tire of claim 1 wherein a period of the sine wave pattern is in the range of 75 to 100 mm.

5. The tire of claim 1 wherein an amplitude of the sine wave pattern is in the range of 2.5 to 3.

6. The tire of claim 1 wherein a turn radius of the sine wave pattern is in the range of 50 to 100 mm.

7. The tire of claim 1 wherein a turn radius of the sine wave pattern is less than a 100 mm.

8. The tire of claim 1 wherein the strip of reinforcement cord has a width in the range of 0.25 inch to 0.5 inch.

9. The tire of claim 1 wherein the one or more reinforcement cords is made of nylon.

10. The tire of claim 1 wherein the one or more reinforcement cords is made of nylon 6/6.

11. The tire of claim 1 wherein the one or more reinforcement cords is made of aramid.

12. The tire of claim 1 wherein the one or more reinforcement cords of the strip is formed of a first reinforcement cable and a second reinforcement cable twisted together to form a merged cord, wherein the first reinforcement cord and the second reinforcement cord are formed of different materials.

13. The tire of claim 1 wherein the one or more reinforcement cords of the strip is formed of a nylon reinforcement cable and a aramid reinforcement cable twisted together to form a merged cord.

14. A tire having a jointless cut protector belt that is continuously wound using a strip of one or more reinforcement cords, wherein the one or more reinforcement cords are formed of aramid, nylon or a blend thereof.

15. The tire of claim 13 wherein the cut protector belt is wound in a sine wave pattern.

16. The tire of claim 14 wherein a period of the sine wave pattern is in the range of 75 to 100 mm.

17. The tire of claim 14 wherein an amplitude of the sine wave pattern is in the range of 2.5 to 3 mm.

18. The tire of claim 14 wherein a turn radius of the sine wave pattern is in the range of 50 mm to 100 mm.

19. The tire of claim 13 wherein the strip of reinforcement cord has a width in the range of 0.02 inch to 2 inch.

20. The tire of claim 11 wherein the one or more reinforcement cord is formed of a blend of nylon and aramid.

21. A tire having a jointless cut protector belt, wherein the jointless cut protector belt is continuously wound using a strip of one or more reinforcement cords, in a wavy pattern that extends in the circumferential direction.
